(19) United States
(12) Patent Application Publication
(10) Pub. No.: US 2008/0055795 A1
(43) Pub. Date: Mar. 6, 2008

(54) POWER SUPPLY START-UP CIRCUIT FOR A TRIP UNIT AND CIRCUIT INTERRUPTER INCLUDING THE SAME

(76) Inventor: Theodore J. Miller, Oakdale, PA (US)

Correspondence Address: Martin J. Moran;Eaton Electrical, Inc., Technology & Quality Center, 170 Industry Drive, RIDC PARK West, Pittsburgh, PA, 15275-1032, US

(21) Appl. No.: 11/467,345

(22) Filed: Aug. 25, 2006

(51) Int. Cl. H02H 7/00

(52) U.S. Cl. 361/18

(57) ABSTRACT

A trip unit power supply includes a current transformer having a primary and a secondary. A full-wave rectifier is structured to rectify the voltage from the secondary and includes an input electrically interconnected with the secondary and an output including a rectified voltage. A field effect transistor is electrically connected in series with a burden resistance. A switching regulator includes an input, a shutdown mode and an output structured to power the trip unit. A startup circuit is powered from the rectified voltage and cooperates with the FET. The startup circuit burdens the secondary through the series combination of the FET and the burden resistor and causes the switching regulator to enter the shutdown mode. The startup circuit removes the burden, exits the shutdown mode and powers the trip unit from the output of the switching regulator when the rectified voltage reaches a predetermined value.

### BACKGROUND OF THE INVENTION

1. Field of the Invention

This invention pertains generally to circuit interrupters and, more particularly, to circuit interrupters including a trip unit and a power supply. The invention also relates to a power supply start-up circuit for a circuit interrupter trip unit.

2. Background Information

Circuit breakers and circuit breaker trip units are well known in the art. See, for example, U.S. Pat. Nos. 5,910,760; 6,144,271; and 6,850,135.

Power for trip unit circuitry is typically provided by an iron core current transformer (CT) which may or may not provide primary current indication. Generally, this CT is regulated to provide a relatively large output voltage to a capacitor which stores energy needed to both energize and trip the trip actuator of the trip unit. Because this CT is capable of supplying only a certain amount of power, a relatively efficient switching power supply is preferred over a relatively less efficient linear regulator to convert the capacitor voltage to a relatively smaller voltage supply (at a relatively higher current) for the signal processing circuitry of the trip unit. Preferably, current-powered trip units run at the lowest possible CT primary current, which current is the same as the load current flowing through the circuit breaker. This is desirable for both display/metering purposes and for protection purposes.

A conventional switching regulator integrated circuit may be electrically connected to receive the capacitor voltage. However, this configuration does not provide the lowest possible current power-up of the trip unit. For example, such lowest possible power-up current is below the level at which the capacitor voltage becomes regulated. Therefore, the CT output voltage (or the switching regulator input voltage) is determined by the burden which is seen by the secondary of the CT.

Given a fixed load requirement, all switching regulators draw more input current from their input power supply at a relatively lower input voltage than at a relatively higher input voltage. Therefore, for a power-limited source, such as a CT secondary when operated at relatively low primary current, the switching regulator will try to “startup” at its minimum operating voltage when the input supply current requirements are the greatest. At relatively low primary current, however, the current output of CT secondary is limited by the CT primary current divided by the number of secondary turns. Hence, the CT cannot provide the necessary secondary current given the relatively low primary current.

Accordingly, there is room for improvement in circuit interrupters and in power supplies for trip units.

### SUMMARY OF THE INVENTION

This need and others are met by embodiments of the invention, which provide a circuit interrupter startup circuit that is powered from a rectified voltage. The startup circuit cooperates with a switch and a burden impedance to: (a) burden the secondary of a current transformer through the series combination of the switch and the burden impedance and cause a switching regulator to enter a shutdown mode, and to: (b) remove the burden, exit the shutdown mode and power a trip unit from the output of the switching regulator when the rectified voltage reaches a predetermined value.

In accordance with one aspect of the invention, a power supply circuit for a trip unit comprises: a current transformer comprising a primary and a secondary including a voltage; a rectifier structured to rectify the voltage from the secondary of the current transformer, the rectifier comprising an input electrically interconnected with the secondary of the current transformer and an output including a rectified voltage; a burden impedance; a switch electrically connected in series with the burden impedance; a switching regulator comprising an input powered from the rectified voltage, a shutdown mode and an output structured to power the trip unit; and a startup circuit powered from the rectified voltage of the output of the rectifier, the startup circuit cooperating with the switch and being structured to: (a) burden the secondary of the current transformer through the series combination of the switch and the burden impedance and cause the switching regulator to enter the shutdown mode, and to: (b) remove the burden, exit the shutdown mode and power the trip unit from the output of the switching regulator when the rectified voltage reaches a predetermined value.

The trip unit may present an impedance or a resistance, and the burden impedance may be structured to approximate the impedance or the resistance of the trip unit.

The switch may be a field effect transistor including a drain, the switching regulator may further comprise a shutdown input corresponding to the shutdown mode, and the drain may be electrically connected to the shutdown input of the switching regulator, the shutdown mode being maintained when the field effect transistor is turned on.

The startup circuit may comprise a comparator and an independent power supply, and the comparator and the independent power supply of the startup circuit may receive the rectified voltage from the output of the rectifier. The switch may be a field effect transistor, and the comparator may be structured to turn the field effect transistor off when the rectified voltage reaches the predetermined value, which is sufficient to power the trip unit, and remove the switching regulator from the shutdown mode thereof.

As another aspect of the invention, a circuit interrupter comprises: separable contacts; an operating mechanism structured to open and close the separable contacts; a sensor structured to sense current flowing through the separable contacts; a trip unit cooperating with the sensor and the operating mechanism to trip open the separable contacts; and power supply comprising: a current transformer comprising a primary and a secondary including a voltage, a rectifier structured to rectify the voltage from the secondary of the current transformer, the rectifier comprising an input electrically interconnected with the secondary of the current transformer and an output including a rectified voltage, a burden impedance, a switch electrically connected in series with the burden impedance, a switching regulator comprising an input powered from the rectified voltage, a shutdown mode and an output structured to power the trip unit, and a startup circuit powered from the rectified voltage of the output of the rectifier, the startup circuit cooperating with the switch and being structured to: (a) burden the secondary of the current transformer through the series combination of the switch and the burden impedance and cause the switching regulator to enter the shutdown mode, and to: (b) remove the burden, exit the shutdown mode and power the trip unit from the output of the switching regulator when the rectified voltage reaches a predetermined value.

The startup circuit may be structured to maintain the shutdown mode at a first voltage and a first current flowing from the secondary of the current transformer until a second voltage and a second current develops at the secondary of the current transformer, the second voltage being greater than the first voltage, the second current flowing from the secondary of the current transformer and enabling the switching regulator to startup.

The startup circuit may comprise a comparator including a first input electrically interconnected with the output of the rectifier and a second input having a threshold voltage, and may further comprise an independent power supply including a zener diode having a positive temperature coefficient, the zener diode being structured to determine the threshold voltage of the second input of the comparator. The positive temperature coefficient of the zener diode may provide temperature compensation to increase the predetermined value responsive to an increase in ambient temperature, in order to remove the burden, exit the shutdown mode and power the trip unit from the output of the switching regulator when the rectified voltage is greater than the predetermined value.

### BRIEF DESCRIPTION OF THE DRAWINGS

A full understanding of the invention can be gained from the following description of the preferred embodiments when read in conjunction with the accompanying drawings in which:

FIG. 1 is a block diagram in schematic form of a circuit breaker in accordance with an embodiment of the invention.

FIGS. 2A and 2B1-2B2 form a block diagram in schematic form of the power supply of the circuit breaker of FIG. 1.

FIG. 3 is a block diagram in schematic form of the trip logic of the circuit breaker of FIG. 1.

### DESCRIPTION OF THE PREFERRED EMBODIMENTS

As employed herein, the statement that a part is “electrically interconnected with” one or more other parts shall mean that the parts are directly electrically connected together or are electrically connected together through one or more electrical conductors or generally electrically conductive intermediate parts. Further, as employed herein, the statement that a part is “electrically connected to” one or more other parts shall mean that the parts are directly electrically connected together or are electrically connected together through one or more electrical conductors.

As employed herein, the term “number” means an integer greater than or equal to one.

The invention is described in association with a three-pole circuit breaker, although the invention is applicable to a wide range of circuit interrupters having any number of poles.

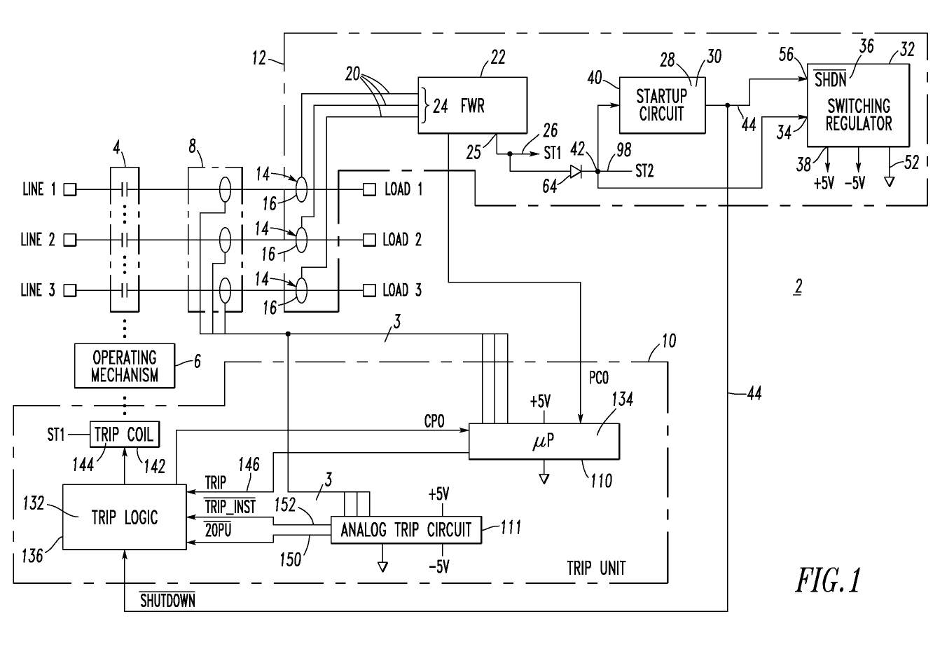

Referring to FIG. 1, a circuit interrupter, such as three-pole circuit breaker 2, includes separable contacts 4, an operating mechanism 6 structured to open and close the separable contacts 4, a sensor 8 structured to sense current flowing through the separable contacts 4, a trip unit 10 cooperating with the sensor 8 and the operating mechanism 6 to trip open the separable contacts 4, and a power supply 12 for the trip unit 10. In this example, the example three-pole circuit breaker 2 includes three separable contacts 4 and three Rogowski coil sensors 8 for sensing the three-phase current flowing through the separable contacts 4, although any suitable current sensor may be employed.

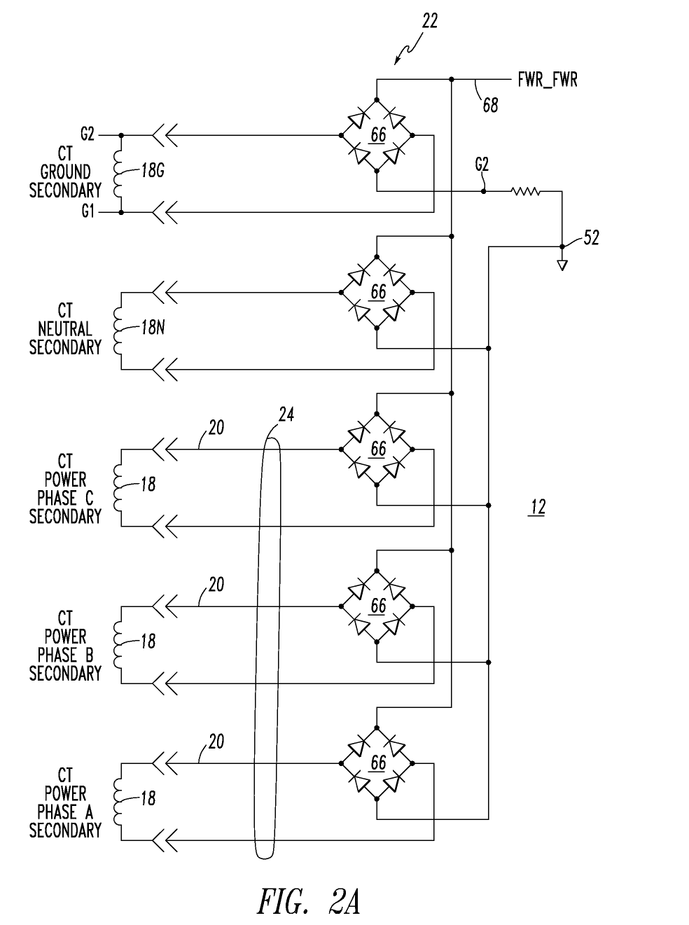

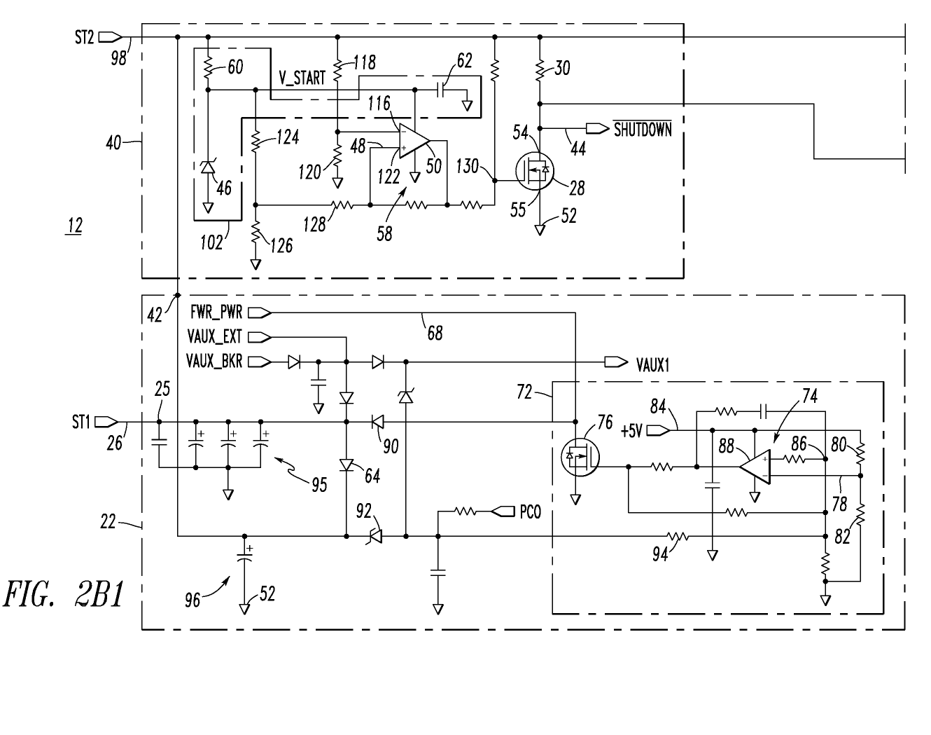

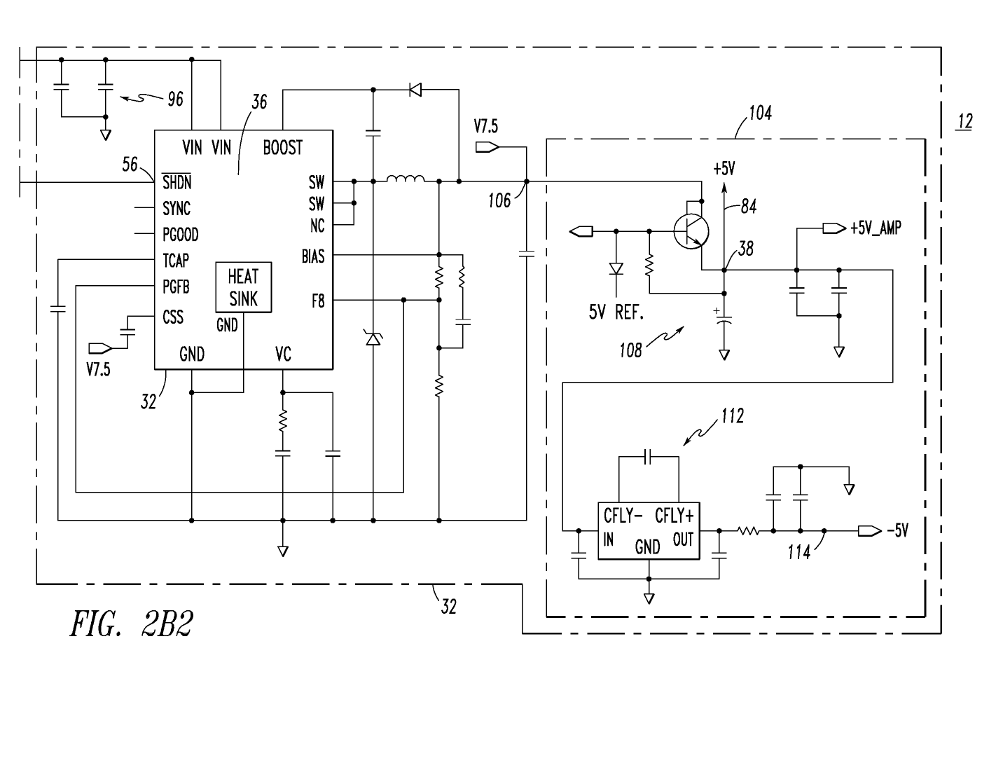

The power supply 12 includes a current transformer (CT) 14 for each pole having a single turn primary coil 16 and a plural turn secondary coil 18 (FIG. 2A) including a secondary voltage 20. A rectifier (FWR) 22 is structured to rectify the CT secondary voltage 20. The rectifier 22 includes an input 24 electrically interconnected with the CT secondary 18 and an output 25 having a rectified voltage (ST1) 26. As part of a startup circuit 40, a switch, such as field effect transistor (FET) 28 (FIG. 2B1), is electrically connected in series with a burden impedance, such as resistor 30 (FIG. 2B1). A switching regulator 32 includes an input 34 powered from the rectified voltage ST1 26 through diode 64, a shutdown mode 36 and an output 38 structured to power the trip unit 10. The startup circuit 40 is powered from the rectified voltage 26 and cooperates with the FET 28 to, at a relatively very low load current, burden the CT secondary 18 through the series combination of the FET 28 and the burden resistor 30 and cause the switching regulator 32 to enter the shutdown mode 36. The startup circuit 40 removes the burden, exits the shutdown mode 36 and powers the trip unit 10 from the switching regulator output 38 when the rectified voltage 26 reaches a suitable predetermined value, as will be discussed.

### EXAMPLE 1

The example startup circuit 40 permits the trip unit 10 to power up when the power signal ST2 98 from the output 42 of the cathode of diode 64 to the switching resistor input 34 reaches about 16 VDC. The burden resistor 30 burdens the power coils 14 with the approximate trip unit load at about 16 VDC. This allows the trip unit 10 to power up at relatively lower primary currents of the power coils 14. The signal SHUTDOWN/44 (at SHDN/ input 56 of FIG. 2B2) holds the switching regulator 32 in the shutdown mode 36 until sufficient power from the power coils 14 is available. An example of the switching regulator 32 is a model LT3434 step-down switching regulator marketed by Linear Technology of Milpitas, Calif.

### EXAMPLE 2

Normally, the load current of the trip unit 10 is provided from about 30 mA at 20 VDC and 15 mA at 40 VDC at power signal ST2 98. Normally, the load current of the trip unit 10 is about 25 mA pulled from the +5V output 38. This represents about 20 mA from power signal ST2 98 running at 20 VDC and about 15 mA from ST2 when running at 40 VDC. The important point is that the current requirement from ST2 decreases as the voltage of ST2 increases because of the switching regulator 32 providing the +5V. Without the startup circuit 40, as primary current increases, the voltage at ST2 will be pulled down to the minimum operating voltage of the switching regulator 32 as it uses all the available current in an attempt to meet its demand (i.e., startup of the trip unit 10 at the regulator's specified output voltage). The trip unit 10 will finally startup when the available current is large enough to run the trip unit 10 at the regulator's minimum operating voltage.

If the voltage at ST2 is allowed to increase above the switching regulator's minimum voltage, startup at lower primary or secondary currents is possible. However, the increase in voltage at ST2 must be restrained somewhat since CT voltages increase rapidly with no burden resistors. In the case of no burden resistor, the normal operating voltage would be reached before sufficient operating current is available. By placing a resistive burden across the full wave rectified CT output, which is representative of the trip unit load current, while holding the trip unit switching regulator 32 off, it is possible to start the trip unit 10 at a lower current. When the desired operating voltage at ST2 is reached, if the burden resistor is chosen properly, then the switching regulator 32 can be taken out of shutdown at the same time that the burden resistor is removed. If this is done, then the trip unit 10 will startup with no change in the ST2 voltage.

### EXAMPLE 3

As shown in FIG. 2B1, a zener diode 46 provides temperature compensation. If the ambient temperature increases, then the zener voltage increases and the corresponding reference voltage 48 (e.g., without limitation, about +1.0 VDC) increases. This requires that the voltage of the signal ST2 98 is suitably high before the SHUTDOWN/ signal 44 is deactivated by the comparator 50 and the FET 28.

### EXAMPLE 4

Referring again to FIG. 1, given a predetermined primary current for the CT 14 that supplies power to the trip unit 10, enough secondary current may be available at relatively higher CT secondary voltages if those voltages are given time to develop. The disclosed power supply 12 allows those relatively higher CT secondary voltages to develop, in order that the switching regulator 32 and, therefore, the trip unit 10 are both able to “startup” at a relatively lower CT primary current.

This is accomplished by initially (at relatively very low primary current) burdening the CT secondary 18 with the resistive load of burden resistor 30 rather than with the switching regulator 32 and the trip unit 10. This resistive load is electrically interconnected with the CT secondary 18 (and the rectified CT voltage 20 thereof) by the FET 28 tied to circuit ground 52. The resistance of the burden resistor 30 is selected such that its power dissipation at minimum operating conditions is equal to or slightly greater than that of the trip unit 10 operating under the same conditions. As shown in FIG. 2B1, the drain 54 of the FET 28 is electrically connected to the shutdown pin (SHDN/) 56 of the switching regulator 32, thereby keeping it in a high impedance state when the FET 28 is off. A relatively very low power comparator circuit 58 with its own simple and independent power supply 102 provided by resistor 60, zener diode 46 and capacitor 62 is used to sense the rectified CT voltage ST1 26 through diode 64 at power signal ST2 98. When the rectified CT voltage ST1 26 reaches a predetermined level, which is sufficient to power the trip unit 10, the FET 28 is turned off. This removes the resistive burden of resistor 30 and takes the switching regulator 32 out of its shutdown mode 36. As a result, the trip unit 10 “starts-up” cleanly at a relatively lower primary current than without such a circuit and without any “false starts”. Otherwise, a false start would occur when the power supply 12 turns on and then turns off because not quite enough power is available to maintain its operation.

The trip unit 10 presents a resistance to the switching regulator 32 (e.g., on the outputs +5 VDC and −5 VDC). The burden impedance, resistor 30, is structured to approximate the resistance or impedance presented by the trip unit 10. The CT secondary 18 (FIG. 2A) is initially burdened by the resistor 30, rather than by the switching regulator 32 and the trip unit 10, until the rectified voltage FWR_PWR 68 reaches the predetermined value (e.g., without limitation, about +20 VDC).

### EXAMPLE 5

Referring to FIGS. 2A and 2B1-2B2, the power supply 12 of the circuit breaker 2 of FIG. 1 is shown. As shown in FIG. 2A, one or more full-wave rectifiers 66 of the rectifier 22 cooperate with one or more CT secondaries (e.g., CT secondaries 18 of one or more power phases A, B and C). Although not required, one or more optional full-wave rectifiers 66 may be employed for a CT secondary 18N for a neutral conductor N (not shown) and/or for a CT secondary 18G for a ground conductor (not shown). The outputs of the one or more full-wave rectifiers 66 establish the full-wave rectified signal FWR_PWR 68 and the circuit ground 52.

Referring to FIGS. 2B1-2B2, the full-wave rectified signal FWR_PWR 68 is preferably approximately limited to a suitable magnitude by a regulator circuit 72 including a comparator circuit 74 and a FET 76. The reference signal 78 for the comparator circuit 74 is established by resistors 80,82 that suitably divide the output voltage (+5 VDC) 84 of the power supply output 38. When the magnitude of the full-wave rectified signal FWR_PWR 68 is too large, the voltage at node 86 exceeds the voltage of the reference signal 78, which turns the output of comparator 88 on. This turns the FET 76 on to further load the full-wave rectified signal FWR_PWR 68, in order to reduce the voltage thereof. The voltage at node 86 is responsive to the voltage of the full-wave rectified signal FWR_PWR 68 through diode 90, diode 64, zener diode 92 and resistor 94. The rectified voltage (ST1) 26, which is established at output 25 from the full-wave rectified signal FWR_PWR 68 through the diode 90, is suitably maintained by capacitors 95. The rectified voltage (ST2) 98 at output 42, which is established from the rectified voltage (ST1) 26 through the diode 64, is suitably maintained by capacitors 96. For example, the trip unit 10 will power up before the regulator circuit 72 starts regulating (e.g., at about 40 VDC).

The startup circuit burden impedance of resistor 30 is a predetermined resistance structured to provide a first power dissipation at the rectifier output 42. The trip unit 10 (FIG. 1) is structured to provide a second power dissipation at the rectifier output 42, in which the first power dissipation is greater than or equal to the second power dissipation of the trip unit 10. The startup circuit burden resistor 30 is electrically connected to the rectifier output 42 having the signal ST2 98. The drain 54 of the FET 28 is electrically connected to the resistor 30, and the source 55 of the FET 28 is electrically connected to circuit ground 52. The switching regulator 32 includes the shutdown pin (SHDN/) 56 corresponding to the shutdown mode 36 of the switching regulator 32. The FET drain 54 is also electrically connected to the switching regulator shutdown pin SHDN/ 56. The switching regulator shutdown mode 36 is maintained when the FET 28 is turned on.

The startup circuit 40 includes the comparator 50 and an independent, relatively low current power supply 102 formed by the zener diode 46, the resistor 60 and the capacitor 62. The comparator 50 and the power supply 102 receive the rectified voltage ST2 98 from the rectifier output 42 through the diodes 90 and 64 from the rectified voltage FWR_PWR 68. The comparator 50 is structured to turn the FET 28 off when the rectified voltage FWR_PWR 68 reaches the predetermined value (e.g., without limitation, about +20 VDC), which is sufficient to power the trip unit 10 with the CT burdened by resistor 30, and remove the switching regulator 32 from the shutdown mode 36 thereof.

The startup circuit 40 is structured to maintain the switching regulator shutdown mode 36 at a first voltage and a first current flowing from the CT secondary 18 until a suitable second voltage and a second current develop at the CT secondary 18. The second voltage is greater than the first voltage. For example, for increasing voltage, the startup circuit 40 will turn on at about 20 VDC at ST1 26 and turn off at about 18 VDC for decreasing voltage at ST1 (i.e., hysteresis is preferably employed). The second current flows from the CT secondary 18 and enables the switching regulator 32 to startup. In accordance with an important aspect of this embodiment, the switching regulator 32 starts up without any “false starts”. Otherwise, a false start would occur when the power supply 12 turns on and then turns off because not quite enough power is available to maintain its operation.

Continuing to refer to FIG. 2B2, the trip unit 10 includes a linear regulator 104 structured to power the trip unit 10. The switching regulator output 106 energizes the linear regulator 104. A first linear regulator circuit 108 provides the +5 VDC output 38 to power microprocessor (μP) 110 and analog trip circuit 111 of FIG. 1. A charge pump inverter circuit 112, which is powered from the first linear regulator circuit 108, provides a −5 VDC output 114 to power the analog trip circuit 111.

The comparator 50 of the startup circuit 40 has a first input (−) 116 electrically interconnected with the rectifier output 42 through a divider formed by resistors 118,120, and also has a second input (+) 122 with the threshold voltage 48. The zener diode 46 of the startup circuit 40 has a positive temperature coefficient. The zener diode 46 is structured to determine the threshold voltage 48 of the comparator second input (+) 122 through another divider formed by resistors 124,126 and through resistor 128. The positive temperature coefficient of the zener diode 46 provides temperature compensation to increase (decrease) the predetermined value (e.g., without limitation, about +1.0 VDC over the full temperature range) of the threshold voltage 48 responsive to an increase (decrease) in ambient temperature. As a result, the startup circuit 40 removes the burden, exits the switching regulator shutdown mode 36 and powers the trip unit 10 from the switching regulator output 42 when the rectified voltage 68 is greater (less) than the predetermined value (e.g., without limitation, about +20 VDC). The startup circuit comparator 50 and the power supply 102 receive the rectified voltage ST2 98 from the rectifier output 42. The comparator 50 is structured to turn the gate 130 of the FET 28 off when the voltage of the CT secondary 18 reaches the predetermined value, which is sufficient to power the trip unit 10, and remove the switching regulator 32 from the shutdown mode 36 thereof.

### EXAMPLE 6

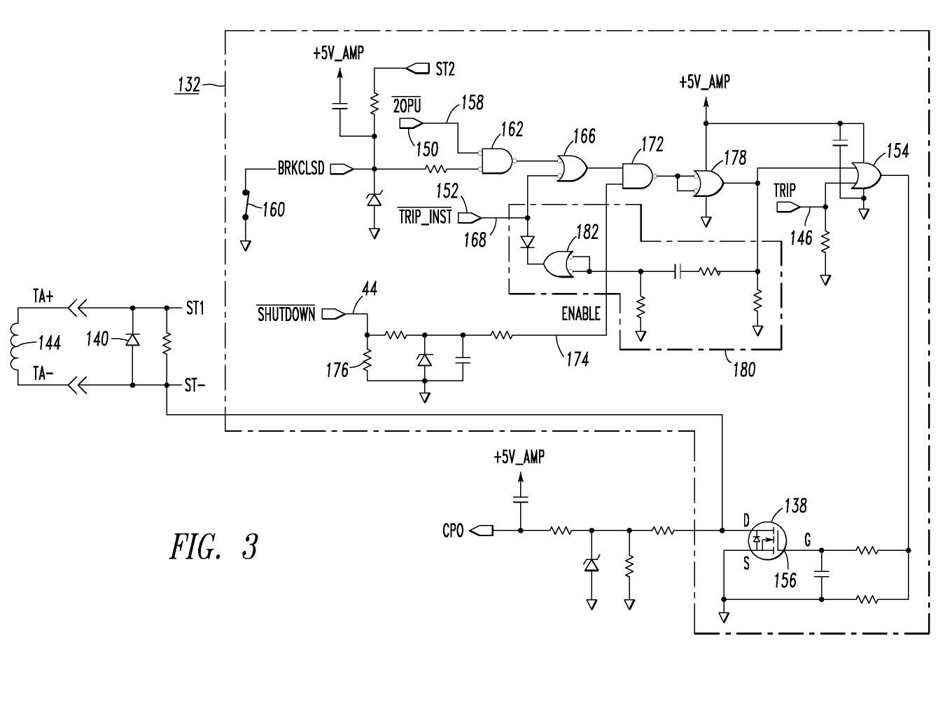

FIG. 3 shows the trip logic circuit 132 of the circuit breaker 2 of FIG. 1. The trip unit 10 of FIG. 1 includes the analog trip circuit 111, a digital trip circuit 134 of μP 110 and trip logic 136. The trip logic 136 cooperates with the startup circuit 40 to disable the outputs (20 PU/ and TRIP_INST/) of the analog trip circuit 111 when the switching regulator 32 has entered the shutdown mode 36 thereof until the SHUTDOWN/ signal 44 has gone high for a predetermined time (e.g., about 1 ms). The power supply 12 includes a number of the capacitors 95 (FIG. 2B1), and the trip unit 10 includes a FET 138, a diode 140 and a trip actuator 142 (FIG. 1) having a trip coil 144. The trip actuator 142 cooperates with the operating mechanism 6 to trip open the separable contacts 4. The CT secondary 18 cooperates with the capacitors 95 and the diode 90 (FIG. 2B1) to charge the capacitors 95 through the diode 90, in order to store energy to energize and trip the trip unit trip actuator 142.

The circuit breaker 2 is tripped by either a digital trip signal 146 from μP 110 or a second trip signal 148 that is derived from the outputs 150,152 of the analog trip circuit 111. An OR gate 154 turns on the gate 156 of the FET 138 to trip the circuit breaker 2 in response to either one of the signals 146,148. The 20PU/ trip signal 158 is disabled by the auxiliary switch 160, which opens about 25 mS after the circuit breaker 2 closes. During that time interval, when the auxiliary switch 160 is closed, the analog trip circuit 111 can trip the circuit breaker 2 responsive to load current greater than or equal to 20 per unit of the circuit breaker rated current. The OR gate 162 (shown in reverse logic form) passes a qualified 20PU/ trip signal 164 to one input of NAND gate 166 (shown in reverse logic form). The other input of NAND gate 166 receives the instantaneous (INST/) trip signal 168 from the output 152 of the analog trip circuit 111. The output of the NAND gate 166 has a combined signal 170 and is electrically connected to one input of NAND gate 172. The other input of the NAND gate 172 has an ENABLE signal 174, which is low whenever the SHUTDOWN/ signal 44 is active (i.e., low). Whenever the SHUTDOWN/ signal 44 is inactive (i.e., high), the voltage of the ENABLE signal 174 is established by the voltage of signal ST2 98 (which voltage is about one diode drop below the voltage of the signal ST1 26) and the divider formed by the resistor 30 (FIG. 2B1) and resistor 176. This ensures that the analog trip circuit 111 has sufficient operating voltage before any of its outputs 150,152 are considered by the trip logic 136. The output of the NAND gate 172 is inverted by the NAND gate 178 to output the second trip signal 148. A circuit 180 including NAND gate 182 and diode 184 permits a momentary instantaneous trip signal 168 to initiate the second trip signal 148 of suitable duration.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A power supply circuit for a trip unit, said power supply circuit comprising:
a current transformer comprising a primary and a secondary including a voltage;
a rectifier structured to rectify the voltage from the secondary of said current transformer, said rectifier comprising an input electrically interconnected with the secondary of said current transformer and an output including a rectified voltage;
a burden impedance;
a switch electrically connected in series with said burden impedance;
a switching regulator comprising an input powered from said rectified voltage, a shutdown mode and an output structured to power said trip unit; and
a startup circuit powered from the rectified voltage of the output of said rectifier, said startup circuit cooperating with said switch and being structured to: burden the secondary of said current transformer through the series combination of said switch and said burden impedance and cause said switching regulator to enter said shutdown mode, and to: remove said burden, exit said shutdown mode and power said trip unit from the output of said switching regulator when said rectified voltage reaches a predetermined value.

2. The power supply circuit of claim 1 wherein said trip unit presents an impedance or a resistance; and wherein said burden impedance is structured to approximate the impedance or the resistance of said trip unit.

3. The power supply circuit of claim 2 wherein the secondary of said current transformer is initially burdened by said burden impedance rather than by said switching regulator until said rectified voltage reaches said predetermined value.

4. The power supply circuit of claim 1 wherein said burden impedance is a resistor.

5. The power supply circuit of claim 4 wherein said switch is a field effect transistor including a drain electrically connected to said resistor.

6. The power supply circuit of claim 1 wherein said switch is a field effect transistor including a drain; wherein said switching regulator further comprises a shutdown input corresponding to said shutdown mode; and wherein said drain is electrically connected to the shutdown input of said switching regulator, said shutdown mode being maintained when said field effect transistor is turned on.

7. The power supply circuit of claim 1 wherein said startup circuit comprises a comparator and an independent power supply; and wherein said comparator and the independent power supply of said startup circuit receive said rectified voltage from the output of said rectifier.

8. The power supply circuit of claim 7 wherein said switch is a field effect transistor; and wherein said comparator is structured to turn said field effect transistor off when said rectified voltage reaches said predetermined value, which is sufficient to power said trip unit, and remove said switching regulator from the shutdown mode thereof.

9. The power supply circuit of claim 1 wherein said burden impedance is electrically connected to the output of said rectifier; and wherein said switch is electrically connected between said burden impedance and ground.

10. The power supply circuit of claim 1 wherein said predetermined value is at least about 20 volts.

11. A circuit interrupter comprising:
separable contacts;
an operating mechanism structured to open and close said separable contacts;
a sensor structured to sense current flowing through said separable contacts;
a trip unit cooperating with said sensor and said operating mechanism to trip open said separable contacts; and
a power supply comprising:
a current transformer comprising a primary and a secondary including a voltage,
a rectifier structured to rectify the voltage from the secondary of said current transformer, said rectifier comprising an input electrically interconnected with the secondary of said current transformer and an output including a rectified voltage,
a burden impedance,
a switch electrically connected in series with said burden impedance,
a switching regulator comprising an input powered from said rectified voltage, a shutdown mode and an output structured to power said trip unit, and
a startup circuit powered from the rectified voltage of the output of said rectifier, said startup circuit cooperating with said switch and being structured to: burden the secondary of said current transformer through the series combination of said switch and said burden impedance and cause said switching regulator to enter said shutdown mode, and to: remove said burden, exit said shutdown mode and power said trip unit from the output of said switching regulator when said rectified voltage reaches a predetermined value.

12. The circuit interrupter of claim 11 wherein said startup circuit is structured to maintain said shutdown mode at a first voltage and a first current flowing from the secondary of said current transformer until a second voltage and a second current develops at the secondary of said current transformer, said second voltage being greater than said first voltage, said second current flowing from the secondary of said current transformer and enabling said switching regulator to startup.

13. The circuit interrupter of claim 11 wherein said burden impedance is a resistor including a predetermined resistance structured to provide a first power dissipation at the output of said rectifier; wherein said trip unit is structured to provide a second power dissipation at the output of said rectifier; and wherein said first power dissipation is greater than or equal to said second power dissipation of said trip unit.

14. The circuit interrupter of claim 11 wherein said sensor is a Rogowski coil.

15. The circuit interrupter of claim 11 wherein said trip unit includes a linear regulator structured to power said trip unit; and wherein the output of said switching regulator energizes said linear regulator.

16. The circuit interrupter of claim 11 wherein said power supply includes a capacitor; wherein said trip unit includes a diode and a trip actuator cooperating with said operating mechanism to trip open said separable contacts; and wherein the secondary of said current transformer cooperates with said capacitor and said diode to charge said capacitor through said diode, in order to store energy to energize and trip the trip actuator of said trip unit.

17. The circuit interrupter of claim 11 wherein said startup circuit comprises a comparator including a first input electrically interconnected with the output of said rectifier and a second input having a threshold voltage, and further comprises an independent power supply including a zener diode having a positive temperature coefficient, said zener diode being structured to determine the threshold voltage of the second input of said comparator; and wherein the positive temperature coefficient of said zener diode provides temperature compensation to increase said predetermined value responsive to an increase in ambient temperature, in order to remove said burden, exit said shutdown mode and power said trip unit from the output of said switching regulator when said rectified voltage is greater than said predetermined value.

18. The circuit interrupter of claim 11 wherein said startup circuit comprises a comparator and an independent power supply; wherein said comparator and the independent power supply of said startup circuit receive the rectified voltage from the output of said rectifier; wherein said switch is a field effect transistor including a gate; and wherein said comparator is structured to turn the gate of said field effect transistor off when the voltage of the secondary of said current transformer reaches a predetermined value, which is sufficient to power said trip unit, and remove said switching regulator from the shutdown mode thereof.

19. The circuit interrupter of claim 11 wherein said predetermined value is a first predetermined value; wherein said trip unit comprises an analog trip circuit, a digital trip circuit and trip logic; and wherein said trip logic is structured to cooperate with said startup circuit to disable said analog trip circuit when said switching regulator has entered said shutdown mode until said rectified voltage reaches a second predetermined value, which is greater than said first predetermined value.

20. The circuit interrupter of claim 20 wherein said second predetermined value is about +24 VDC.
